(19) United States
(12) Patent Application Publication
(10) Pub. No.: US 2008/0016757 A1
(43) Pub. Date: Jan. 24, 2008

(54) REAGENT COMPOSITION AND METHOD FOR RECLAIMING CARBONACEOUS MATERIALS FROM SETTLING PONDS AND COAL PREPARATION PLANTS

(76) Inventors: Anthony J. Kriech, Indianapolis, IN (US); Herbert L. Wissel, Indianapolis, IN (US); Todd E. Dobbs, Westfield, IN (US)

Correspondence Address: BUTZEL LONG, 350 SOUTH MAIN STREET, SUITE 300, ANN ARBOR, MI, 48104, US

(21) Appl. No.: 11/756,739

(22) Filed: Jun. 1, 2007

Related U.S. Application Data
(60) Provisional application No. 60/810,732, filed on Jun. 2, 2006.

(51) Int. Cl. C10L 5/00; B01D 21/01; C10L 5/02; C02F 1/52

(52) U.S. Cl. 44/620; 210/710; 210/723

(57) ABSTRACT

A reagent mixture comprising a hydrocarbon emulsion and an adhesion promoter which is used to agglomerate carbonaceous material particles from coal slurries of settling ponds or coal processing plants. The reagent mixture inhibits or avoids co-agglomeration of noncombustible impurities such as clay present in the slurries. The reagent mixture is provided as at least one of a slurry, a suspension, an emulsion and a solution which is contacted with the coal slurry.

### RELATED APPLICATION

The present application is based upon U.S. Provisional Patent Application Ser. No. 60/810,732, filed Jun. 2, 2006 and claims priority thereto under 35 U.S.C. §120.

### TECHNICAL FIELD

The present invention relates generally to the field of reclaiming and utilizing carbonaceous materials. More particularly, the present invention relates to a reagent composition and methods for reclaiming and utilizing carbonaceous materials from settling ponds and coal preparation plants.

### BACKGROUND ART

In the cleaning or washing of coal for commercial use as a fuel and the like, the uncombustible ash content of coal is usually removed to enhance the heat content of the coal. Reduction in the ash content results in a savings of transportation and ash disposal costs. Other materials frequently occurring in coals that may be removed in washing operations include various clays and sulfides. Such clays commonly include aericite (KAl₂ (AlSi₃O)(OH)₁₂), smectite (Al₂Si₄O₁₀(OH₁₂)H₂O), and kaolinite clays (Al₂Si₄O₅(OH)₄). Sulfides are usually pyrite (FeS₄ (isometrical)).

During the processing of coal to affect such washing, a coal refuse slurry is generated. This slurry comprises coal fines known as tailings, and contaminants such as clay and mud suspended in plant process water. Due to the high volume of water used in the processing of coal, it is necessary to reclaim the wash water for recirculation in the plant. The concentrated solids are sent to impoundment ponds or refuse piles for storage/disposal. In some cases in which coal washing plants have been operating for years, such slurry ponds or refuse piles may occupy hundreds of acres and may contain millions of tons of coal fines. These slurry ponds or refuse piles may also contain coal slurry to a depth of 70-150 feet. Such slurry ponds or refuse piles not only occupy a great deal of valuable land, but they also contain a considerable amount of energy and water resources.

In addition to washing coal, coal slurries may originate from a number of sources or stages in the preparation and handling of coal, such as from underflow from thickening operations, from water used in concentrating or separating tables, from overflow from chance cone systems, or from wet scrubbings from dust collectors utilized on drying or handling operations.

Throughout the country, there are many active and dormant settling ponds or refuse piles containing valuable coal fines. Although the chemical makeup of the fine coal in the ponds or refuse piles varies considerably, many contain coal which is of recoverable value. The coal in these ponds or refuse piles is generally in the form of a wet, cakey sludge or slurry containing a considerable amount of moisture, usually about 30% to 40%. The moisture content may vary considerably from location to location. The ash content on a dry basis may vary from approximately 10% to 40% and the sulfur content from approximately 1% to 3%. In addition, the settling ponds or refuse piles exist from both bituminous and anthracite preparation plants, and thus the BTU value of the coal contained in sites may vary substantially for all of the above reasons from location to location.

There are basically two possible ways to economically recover coal sludge from the settling ponds or refuse piles. The first involves drying the sludge down to from 7% to 12% moisture and reblending this material in small percentages into a prepared coal product. The other approach involves agglomerating the fines and using the agglomerate as a fuel source.

A number of methods for agglomeration of coal fines have been proposed, including briquetting of coal fines, extrusion of coal silt and pelletizing. While some encouraging results have been noted, in all three of these agglomeration processes there are primary problems which have heretofore not been adequately or economically resolved.

Attempts to agglomerate coal fines from slurries in settling ponds or coal preparation plants have not been successful in preventing natural soil components, including clays, from agglomerating together with the desired carbonaceous material particles.

The present invention provides a reagent composition and methods for reclaiming and utilizing carbonaceous materials from settling ponds.

### DISCLOSURE OF THE INVENTION

According to various features, characteristics and embodiments of the present invention which will become apparent as the description thereof proceeds, the present invention provides a method of agglomerating carbonaceous materials from coal settling ponds or coal preparation plants which involves:

a) obtaining a carbonaceous particle containing slurry from a coal settling pond or coal preparation plant;

b) substantially uniformly distributing a hydrogen emulsion containing adhesion promoter on the surfaces of the carbonaceous material particles; and

c) allowing the coated carbonaceous material particles in step b) to agglomerate.

The present invention further provides a method of reclaiming a carbonaceous fuel from coal settling ponds or coal preparation plants which involves:

a) obtaining a carbonaceous particle containing slurry from a coal settling pond or a coal preparation plant;

b) treating the carbonaceous particle containing slurry with a combination of a hydrocarbon emulsion and an adhesion promoter to coat the carbonaceous particles;

c) allowing the carbonaceous particles to agglomerate.

The present invention further provides an agglomerated product from a coal settling pond or a coal preparation plant which comprises a product formed by treating a slurry from a coal settlement pond or a coal preparation plant with a reagent mixture comprising a hydrocarbon emulsion and an adhesion promoter so as to agglomerate carbonaceous material particles present in the slurry while reducing co-agglomeration of noncombustible impurities present in the slurry.

### BEST MODE FOR CARRYING OUT THE INVENTION

The present invention is directed to a reagent composition and methods for reclaiming and utilizing carbonaceous materials from settling ponds or coal preparation plants. In particular, the present invention provides a reagent composition which, in addition to agglomerating carbonaceous particles in slurries from coal settling ponds or coal preparation plants, also hinders or avoids the co-agglomeration of undesirable noncombustible impurities, including clay particles. By reducing the amount of uncombustible impurities in the resulting agglomerated carbonaceous particles the heat content of the resulting fuel product is enhanced. The agglomerated fuel product produced by the present invention can be used as a fuel in its agglomerated form or can be formed into briquettes or pellets as desired. The agglomerated fuel product (or briquetted or pelletized product) can be used as a fuel in furnaces in the power production industry and in other combustion systems, including steel and iron processing equipment, in boilers, etc. Although reference is made herein to coal fines, in general examples of carbonaceous materials that can be treated and agglomerated according to the present invention include coal, coal fines, coke, coke breeze, coke fines, revert materials and mixtures thereof.

According to the present invention, the carbonaceous slurry material is treated with a combination of a hydrocarbon emulsion and an adhesion promoter. The treatment involves preparing a suitable slurry or suspension of a hydrocarbon emulsion and an adhesion promoter, separately or in any combination, and combining the slurry, suspension, emulsion or solution with the carbonaceous material particles in the carbonaceous slurry so that at least the hydrocarbon droplets and the adhesion promoter are uniformly distributed on the surfaces of the carbonaceous particles. After treatment, the treated carbonaceous material particles agglomerate and can be pelletized or briquetted, if desired, and otherwise stored or used immediately. During the agglomeration process, the undesirable uncombustible impurities, including clay particles are prevented from being agglomerated together with the carbonaceous material particles.

According to one embodiment, the hydrocarbon emulsion, which is used together with the adhesion promoter, can be produced by emulsifying a distillable liquid petroleum hydrocarbon having a flash point greater than 120° C. (about 25 wt. % to about 70 wt. % of the resulting emulsion) with a surfactant (anionic, cationic or nonionic; about 0.25 to about 5 wt. % of the resulting emulsion) and from about 25 weight percent to about 75 weight percent water, based upon the total weight of the distillable liquid petroleum hydrocarbon, to form the emulsion. This hydrocarbon emulsion (absent an adhesion promoter), its preparation and use are disclosed in U.S. Pat. No. 6,530,966 to Kriech et al. the disclosure of which is hereby expressly incorporated herein by reference.

During the course of the present invention, it was determined that the manner of treating the carbonaceous particles reduces the formation of NOx when the resulting agglomerated fuel product is combusted. This is in part accomplished by producing a uniform coating of the hydrocarbon on the carbonaceous material particles. This uniform distribution of the hydrocarbon keeps the volatilized surfaces of the carbonaceous particles cooler thereby preventing the formation of NOx during combustion. This can be accomplished by spraying the hydrocarbon emulsion containing the adhesion promoter on to the surfaces of the carbonaceous particles in the carbonaceous slurries using any suitable mixer, blender, mill, contacting apparatus, etc. According to further embodiments of the present invention, small amounts of vanadium (e.g., about 0.01 to about 20 ppm), titanium (e.g., about 0.01 to about 0.2 wt. % TiO₂) and ammonia (e.g., one molecule of ammonia for every molecule of NOₓ to be reduced) can be incorporated into the hydrocarbon emulsion to help improve reduction of NOx formation during combustion. Such a method of reducing NOx is disclosed in U.S. Patent Application Publication No. 2006/0090678 to Kriech, the complete disclosure of which is expressly incorporated herein by reference.

The amount of hydrocarbon emulsion used can be from about 2 wt. % to about 10 wt. % of the carbonaceous material.

The adhesion promoter us added to the hydrocarbon emulsion in an amount of from about 0.2 wt. % to about 2 wt. % based on the weight of the hydrocarbon emulsion.

Suitable adhesion promoters are exemplified by those including the Wetfix and Kling Beta series of adhesion promoters from Akzo Nobel, the Adher series of adhesion promoters available from Arr-Maz Products, Idulin CBA-4 and Indulin 814 from Mead Westvaco and the Pave Bond series of adhesion promoters from Rohm & Hass, and any other amine based adhesion promoter.

A method for agglomerating carbonaceous particles from settling pond slurries or coal preparation plants according to one embodiment of the present invention involves contacting carbonaceous material particles in a slurry, e.g. a coal fines slurry from a settling pond, with a hydrocarbon emulsion and an adhesion promoter in a mixer/blender. During the treatment, the treated carbonaceous material is allowed to agglomerate and then can be formed into briquettes or pellets as desired.

The mixers/blenders used in the treating process can be any conventional type of mixer, blender, mill, contacting apparatus, etc. that is capable of uniformly distributing the treating components, i.e. the hydrocarbon emulsion containing the adhesion promoter on the surfaces of the carbonaceous material particles. the agglomeration process, the undesirable uncombustible impurities, including clay particles are prevented from being agglomerated together with the carbonaceous material particles.

According to one embodiment, the hydrocarbon emulsion, which is used together with the adhesion promoter, can be produced by emulsifying a distillable liquid petroleum hydrocarbon having a flash point greater than 120° C. (about 25 wt. % to about 70 wt. % of the resulting emulsion) with a surfactant (anionic, cationic or nonionic; about 0.25 to about 5 wt. % of the resulting emulsion) and from about 25 weight percent to about 75 weight percent water, based upon the total weight of the distillable liquid petroleum hydrocarbon, to form the emulsion. This hydrocarbon emulsion (absent an adhesion promoter), its preparation and use are disclosed in U.S. Pat. No. 6,530,966 to Kriech et al. the disclosure of which is hereby expressly incorporated herein by reference.

During the course of the present invention, it was determined that the manner of treating the carbonaceous particles reduces the formation of NOx when the resulting agglomerated fuel product is combusted. This is in part accomplished by producing a uniform coating of the hydrocarbon on the carbonaceous material particles. This uniform distribution of the hydrocarbon keeps the volatilized surfaces of the carbonaceous particles cooler thereby preventing the formation of NOx during combustion. This can be accomplished by spraying the hydrocarbon emulsion containing the adhesion promoter on to the surfaces of the carbonaceous particles in the carbonaceous slurries using any suitable mixer, blender, mill, contacting apparatus, etc. According to further embodiments of the present invention, small amounts of vanadium (e.g., about 0.01 to about 20 ppm), titanium (e.g., about 0.01 to about 0.2 wt. % TiO₂) and ammonia (e.g., one molecule of ammonia for every molecule of NOₓ to be reduced) can be incorporated into the hydrocarbon emulsion to help improve reduction of NOx formation during combustion. Such a method of reducing NOx is disclosed in U.S. Patent Application Publication No. 2006/0090678 to Kriech, the complete disclosure of which is expressly incorporated herein by reference.

The amount of hydrocarbon emulsion used can be from about 2 wt. % to about 10 wt. % of the carbonaceous material.

The adhesion promoter us added to the hydrocarbon emulsion in an amount of from about 0.2 wt. % to about 2 wt. % based on the weight of the hydrocarbon emulsion.

Suitable adhesion promoters are exemplified by those including the Wetfix and Kling Beta series of adhesion promoters from Akzo Nobel, the Adher series of adhesion promoters available from Arr-Maz Products, Idulin CBA-4 and Indulin 814 from Mead Westvaco and the Pave Bond series of adhesion promoters from Rohm & Hass, and any other amine based adhesion promoter.

A method for agglomerating carbonaceous particles from settling pond slurries or coal preparation plants according to one embodiment of the present invention involves contacting carbonaceous material particles in a slurry, e.g. a coal fines slurry from a settling pond, with a hydrocarbon emulsion and an adhesion promoter in a mixer/blender. During the treatment, the treated carbonaceous material is allowed to agglomerate and then can be formed into briquettes or pellets as desired.

The mixers/blenders used in the treating process can be any conventional type of mixer, blender, mill, contacting apparatus, etc. that is capable of uniformly distributing the treating components, i.e. the hydrocarbon emulsion containing the adhesion promoter on the surfaces of the carbonaceous material particles.

The agglomerated carbonaceous material particles can be used immediately, or stored for later use, as a fuel that can be combusted in a furnace, boiler, or any combustion system in which carbonaceous materials such as coal is combusted. Examples of combustors include power plant furnaces, steel production furnaces, heat treatment furnaces, industrial boiler furnaces, and other carbonaceous fired furnaces, including those of steam powered vessels.

As noted above, the resulting agglomerated carbonaceous materials can be used (combusted) immediately after treatment. Alternatively, the resulting agglomerated carbonaceous materials can be stored or pelletized or briquetted using any conventional techniques, including the use of binders.

As the carbonaceous particles agglomerate during treatment, noncombustible impurities, including clay particles present in the settling pond slurries are precluded from agglomerating with the carbonaceous materials to any significant degree. Accordingly, the heat content of the agglomerated carbonaceous particles is not adversely lowered by the presence of noncombustibles.

Further, as noted above the reagent system used to treat and agglomerate the carbonaceous particles reduces the formation of NOx during the subsequent combustion of the agglomerated carbonaceous particles.

Although the present invention has been described with reference to particular means, materials and embodiments, from the foregoing description, one skilled in the art can easily ascertain the essential characteristics of the present invention and various changes and modifications can be made to adapt the various uses and characteristics without departing from the spirit and scope of the present invention as described above or set forth in the attached claims.

What is claimed is:

1. A method of agglomerating carbonaceous materials from coal settling ponds or coal preparation plants which comprises:
a) obtaining a carbonaceous particle containing slurry from a coal settling pond or a coal preparation plant;
b) substantially uniformly distributing a hydrocarbon emulsion containing an adhesion promoter on the surfaces of the carbonaceous material particles;
c) allowing the carbonaceous particles to agglomerate.

2. A method of agglomerating carbonaceous materials from coal settling ponds or coal preparation plants according to claim 1, wherein at least one of the hydrocarbon of the emulsion and the adhesion promoter is incorporated into at least one of an emulsion, slurry, suspension and solution prior to being distributed onto the surfaces on the carbonaceous material.

3. A method of agglomerating carbonaceous materials from coal settling ponds or coal preparation plants according to claim 1, wherein the carbonaceous material comprises at least one of coal, coal fines, coke, coke breeze, coke fines, revert materials and mixtures thereof.

4. A method of agglomerating carbonaceous materials from coal settling ponds or coal preparation plants according to claim 3, wherein the carbonaceous material is coal fines.

5. A method of agglomerating carbonaceous materials from coal settling ponds or coal preparation plants according to claim 1, wherein the amount of hydrocarbon emulsion is from about 2 wt. % to about 10 wt. % of the carbonaceous material.

6. A method of agglomerating carbonaceous materials from coal settling ponds or coal preparation plants according to claim 5, wherein the amount of the adhesion promoter incorporated is from about 0.2 wt. % to about 2 wt. % of the hydrocarbon emulsion.

7. A method of agglomerating carbonaceous materials from coal settling ponds or coal preparation plants according to claim 1, wherein the carbonaceous materials further include noncombustible impurities, including at least clay materials which are inhibited from becoming agglomerated with the carbonaceous materials.

8. A method of agglomerating carbonaceous materials from coal settling ponds or coal preparation plants according to claim 1, wherein the agglomerated carbonaceous particles are further formed into at least one of briquettes and pellets.

9. A method of reclaiming a carbonaceous fuel from coal settling ponds or coal preparation plants which comprises:
a) obtaining a carbonaceous particle containing slurry from a coal settling pond or coal preparation plant;
b) treating the carbonaceous particle containing slurry with a combination of an hydrocarbon emulsion and an adhesion promoter on the surfaces of the carbonaceous material particles; and
c) allowing the carbonaceous particles to agglomerate.

10. A method of reclaiming a carbonaceous fuel from coal settling ponds or coal preparation plants according to claim 9, wherein the carbonaceous materials further include noncombustible impurities, including at least clay materials which are inhibited from becoming agglomerated with the carbonaceous materials.

11. A method of reclaiming a carbonaceous fuel from coal settling ponds or coal preparation plants according to claim 9, wherein the carbonaceous material comprises at least one of coal, coal fines, coke, coke breeze, coke fines, revert materials and mixtures thereof.

12. An agglomerated product from a coal settling pond or a coal preparation plant which comprises a product formed by treating a slurry from a coal settlement pond or a coal preparation plant with a reagent mixture comprising a hydrocarbon emulsion and an adhesion promoter so as to agglomerate carbonaceous material particles present in the slurry while reducing co-agglomeration of noncombustible impurities present in the slurry.

13. An agglomerated product from a coal settling pond or coal preparation plants according to claim 12, wherein the coal settlement pond or coal preparation plant comprises a source of at least one of coal, coal fines, coke, coke breeze, coke fines, revert materials and mixtures thereof.

14. An agglomerated product from a coal settling pond or coal preparation plants according to claim 12, wherein the reagent mixture comprises at least one of a slurry, a suspension, an emulsion and a solution.
